(19) United States
(12) Patent Application Publication
(10) Pub. No.: US 2006/0014028 A1
(43) Pub. Date: Jan. 19, 2006

(54) Mesostructured film, porous film and the method of preparing the same

(75) Inventor: Miki Ogawa, Tokyo (JP)

Correspondence Address: FITZPATRICK CELLA HARPER & SCINTO, 30 ROCKEFELLER PLAZA, NEW YORK, NY, 10112, US

(73) Assignee: CANNON KABUSHIKI KAISHA, TOKYO (JP)

(21) Appl. No.: 10/521,242

(22) PCT Filed: Aug. 11, 2003
(86) PCT No.: PCT/JP03/10215

§ 371 Date: Jan. 14, 2005

(30) Foreign Application Priority Data
Aug. 9, 2002 (JP) 2002-233026
Aug. 5, 2003 (JP) 2003-286820

(51) Int. Cl. B32B 3/26; B32B 13/04; B32B 9/04

(52) U.S. Cl. 428/446; 428/304.4; 427/226; 427/377

(57) ABSTRACT

It is an object of the present invention to provide a method for preparing mesostructured film having oriented channel structure and which is applicable to preparing mesostructured metal oxide. It is also an object of the present invention to provide meso porous film containing non-silica metal oxide in pore wall and having rod-like pores uniaxially aligned. It is further an object of the present invention to provide method for preparing mesostructured film including the steps of: preparing a reactant solution containing a precursor material for frame of mesostructured material which contains metal oxide, and an amphiphilic material; coating the substrate whose surface has alignment control ability with the reactant solution; and holding the substrate which has been coated with the reactant solution in a vapor-containing atmosphere.

### TECHNICAL FIELD

The present invention relates to a porous material used for catalysts, adsorbents or the like, and more particularly to porous inorganic oxide films in which the tubular pores are uniaxially aligned and a method for preparing such a film.

### BACKGROUND ART

Porous materials have been used in various technical fields such as adsorption and separation.

Zeolites such as natural aluminosilicates or synthesized aluminosilicates, or metal phosphate are known as microporous materials.

Such materials are used for selective adsorption, shape-selective catalytic reactions and molecular-sized reactors.

However, according to reported microporous crystal line materials, pore diameter are about 1.5 nm at the maximum. Therefore, a solid having a larger pore size is demanded for adsorption and reaction of a bulkier compound which is not adsorbed on a micropore.

Silica gels, pillared clays or the like are known as the materials having the larger pores. However, pore size distribution of such a material is broad and the pore size can not readily be controlled.

In the above-mentioned background, two different methods have been developed at about the same time for synthesizing mesoporous silica having mesopores of a uniform size arranged in a honeycomb shape.

The mesoporous silica prepared by one of the methods is a material called MCM-41 which is synthesized by hydrolysis of silicon alkoxide in the presence of a surfactant (described in “Nature” vol. 359, page 710). The other is a material called FSM-16 which is synthesized by intercalation of an alkyl ammonium into the interlayer spaces of kanemite which is a kind of layered polysilicate (described in “Journal of Chemical Society Chemical Communication” vol. 1993, page 680).

In both of such materials, it is considered that a mesostructure of silica is controlled by a surfactant assembly which acts as a template.

Such materials are very useful as catalysts or adsorbents for a bulky molecules which can not enter the pores of zeolite.

Mesoporous silica having such a regular porous structure is known to exhibit various macroscopic morphologies, for example, thin films, fibers, fine spheres and a monoliths.

Because of the controllability of such macroscopic morphologies, mesoporous silica is expected to be applied to functional materials such as optical and electronic materials in addition to catalysts and adsorbents.

Mesostructured materials have been reported with regard to not only silica but also various materials such as a transition metal oxide, metal, sulfide and the like, and application to those materials is widely expected.

For example, as a method for preparing a mesostructured various inorganic oxides, preparation of mesostructured ZrO₂, TiO₂, N₂O₅, Ta₂O₅, WO₃, SnO₂, HfO₂, Al₂O₃ and SiO₂ are reported in “NATURE” vol. 396, page 152 (1998).

However, such methods provide mesostructured inorganic oxide films with randam pore orientation.

Furthermore, if a currently known method for preparing a mesostructured silica thin film having a uniaxially aligned tubular pores is directly applied to other materials, uniaxially aligned tubular pores have not yet been obtained satisfactorily. Therefore, a new development method has been demanded.

As described above, a material with which a thin film having an uniaxially aligned tubular pores can be formed is currently limited to silica. Therefore, expansion to a material other than silica (non-silica materials) such as transition metal oxides, metals or sulfides has been eagerly demanded so that a thin film having a mesostructure is widely used as a functional material.

### DISCLOSURE OF THE INVENTION

Therefore, according to the present invention, there is provided a method for producing a porous film including the steps of: preparing a reaction solution containing a precursor material for a porous material which contains metal oxide, and an amphiphilic material; applying the reaction solution onto a substrate having a capability of orienting an aggregate of the amphiphilic material in a predetermined direction; and forming the porous material having a plurality of the aggregates of the amphiphilic material oriented in the predetermined direction while holding the substrate onto which the reaction solution has been applied in a vapor-containing atmosphere.

Also, there is provided a method for producing a porous film including the steps of: preparing a reaction solution containing a precursor material for a porous material which contains metal oxide, and an amphiphilic material; applying the reaction solution onto a substrate having a capability of orienting an aggregate of the amphiphilic material in a predetermined direction; forming the porous material having a plurality of the aggregates of the amphiphilic material oriented in the predetermined direction while holding the substrate onto which the reaction solution has been applied in a vapor-containing atmosphere; and removing the amphiphilic material to form a pore.

Further, there is provided a porous film on a substrate, the porous film having a plurality of tube-shaped pores oriented in a predetermined direction and containing a metal oxide in its pore wall.

### BRIEF DESCRIPTION OF THE DRAWINGS

FIG. 1 is a process chart illustrating a method for forming a mesostructured material in the present invention.

FIG. 2 is a schematic view illustrating an apparatus for preparing an LB film used in the present invention.

FIG. 3 is a schematic view illustrating a coating pattern of the reactant solution made in example of the present invention.

FIG. 4 is a schematic view illustrating a pattern of a transparent thin film on a substrate made in example of the present invention.

FIG. 5 is a process chart illustrating a method for forming a mesoporous material having hollow pores in the present invention.

FIG. 6 is a schematic view illustrating a film formed on a substrate in Example 4 of the present invention.

### BEST MODE FOR CARRYING OUT THE INVENTION

Hereinafter, the present invention will be described by showing preferred embodiments.

### Embodiment 1

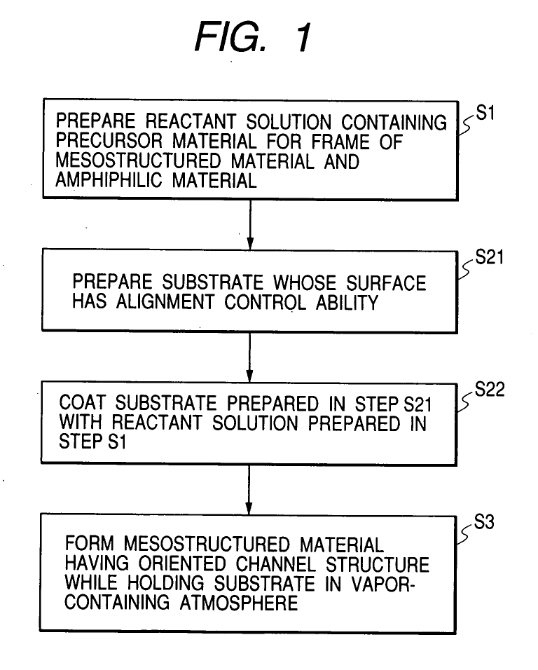

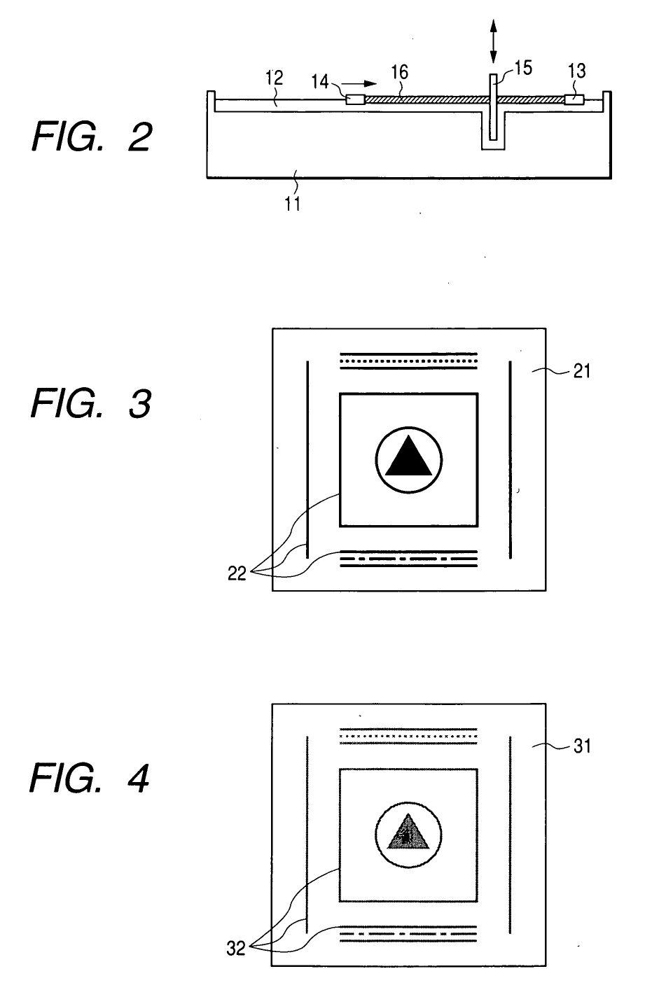

A method for preparing a mesostructured inorganic oxide film according to the present invention will be described with referring to FIG. 1.

FIG. 1 is a process chart illustrating a method for forming a mesostructured inorganic oxide in the present invention. In FIG. 1, a step S1 includes preparing a reactant solution containing a precursor material which forms a main frame of a mesostructure by hydrolysis and condensation, and an amphiphilic material; a step S21 includes preparing a substrate whose surface has alignement control ability; a step S22 includes coating the substrate whose surface has alignement control ability with the reactant solution and a step S3 includes forming a mesostructured material having uniaxially aligned assemblies of the amphiphilic materials while holding the substrate in a vapor-containing atmosphere.

By performing the steps S1 to S3, a mesostructured film is formed on the substrate.

The reason why such a structure is formed is because self-assembly of the amphiphilic material is promoted and a micelle (an assembly) which acts as a template is formed.

A mesostructured material having a highly ordered structure can be obtained by performing the step S3. Furthermore, a mesostructured film having oriented channel structure can be obtained by preparing a substrate whose surface has alignement control ability and forming the mesostructured film on the substrate.

Furthermore, in the case where a tin-containing compound or the like is used as a precursor material, a mesostructured film containing a tin oxide crystal in a pore wall can be obtained by performing the step S3.

In the present specification, the term “crystal” means a structure having a higher ordering compared to an amorphous material and includes a singlecrystal, a polycrystal and a monocrystal.

Hereinafter, each of the steps S1 to S3 will be described in detail. A mesostructured film having an oriented channel structure can be formed by a preparing method according to the present invention. The mesostructured film formed on a substrate, produced by this method, contains an amphiphilic material such as a surfactant in the pore.

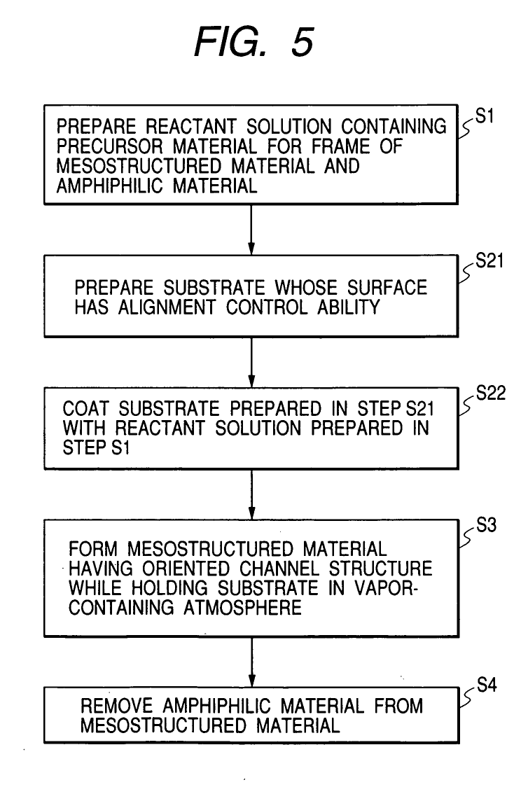

Furthermore, as shown in FIG. 5, a mesoporous film having an oriented channel structure can be formed by performing a step S4 to remove the amphiphilic material from the mesostructured film.

(Step S1: Preparation of Reactant Solution)

Initially, a reactant solution is prepared. The reactant solution contains: a precursor material for a frame of mesostructured material containing a metal oxide (hereinafter, merely referred to as “a precursor material”); an amphiphilic material; and a solvent.

Preferred examples of the solvent for the reactant solution used in the present invention include an alcohol such as ethanol, methanol, propanol or butanol. However, the solvent is not limited thereto and any solvent capable of dissolving a precursor material and an amphiphilic material both of which will be described later can be preferably used.

A mixed solvent of two or more alcohols can also be used.

In the case where a material such as titanium isopropoxide having a high reactivity with water is used as a precursor material described later, when the solvent and the precursor material are mixed, a precipitate is intensively produced so there are possibilities that formation of a uniform film is prevented. Therefore, it is desirable to remove water from the solvent as much as possible.

On the other hand, in the case where a material such as tin chloride which is relatively stable in a solution and which does not produce a precipitate intensively is used as a precursor material, removal of water from a solvent is not necessarily required. Furthermore, a mixed solvent of water and alcohol, or water itself can be used as a solvent.

Optionally, an acid such as hydrochloric acid or a base such as ammonium hydroxide can be appropriately added to adjust pH of the reactant solution or to control hydrolysis and condensation rates of a precursor material.

A precursor material and an amphiphilic material are added to the solvent.

A mesostructured film according to the present invention contains a metal oxide. Examples of the metal include Ti, Zr, Nb, Ta, Al, Si, Sn, W and Hf. Especially, since tin oxide indicates semiconductor characteristics, tin oxide is expected to be applied to an optical device, a gas sensor, or the like.

Accordingly, metal halide (e.g., chloride of the above-mentioned metal) or metal alkoxide (e.g., isopropoxide or ethoxide of the above-mentioned metal) is suitable as a precursor material, and metal chloride is especially preferably used. However, the precursor material is not limited thereto.

Furthermore, a mesostructured film containing a crystal in pore wall can be formed by using, for example, a precursor material of tin oxide.

In the case of forming a mesostructured film containing a tin oxide crystal in a pore wall, tin or a tin compound such as a tin chloride (e.g., stannous chloride or stannic chloride), or a tin alkoxide (e.g., tin isopropoxide or tin ethoxide) can be used and stannic chloride is especially preferred. In the present specification, the term “mesostructured material containing crystal in pore wall” includes, for example, the case where pore wall of a mesostructured material substantially contains microcrystal.

A surfactant is suitable as an amphiphilic material and a nonionic surfactant containing polyethylene oxide as a hydrophilic group is preferably used. However, the surfactant is not limited thereto.

The molecular length of the surfactant to be used is designed depending on desired pore size.

For example, polyoxyethylene (10) dodecylether <C₁₂H₂₅(CH₂CH₂O)₁₀OH>, polyoxyethylene (10) tetradecylether <C₁₄H₂₉(CH₂CH₂O)₁₀OH>, polyoxyethylene (10) hexadecylether <C₁₆H₃₃(CH₂CH₂O)₁₀OH>, or polyoxyethylene (10) stearylether <C₁₈H₃₇ (CH₂CH₂O)₁₀OH> is preferred for forming a mesostructure applicable to the present invention. A pore size can be reduced by reducing an alkyl chain length.

Furthermore, a pore size can be increased or reduced by varying a polyethylene oxide chain length.

A pore having a larger size can be formed by using a so-called triblock copolymer such as HO(CH₂CH₂O)₂₀(CH₂CH(CH₃) 0)₇₀(CH₂CH₂O)₂₀H.

Additives can be added to adjust size of surfactant micelle.

A reactant solution can be prepared by performing the above-mentioned steps.

(Steps S21 and S22: Coating Substrate Whose Surface has Alignment Control Ability with Reactant Solution.)

Next, the substrate whose surface has alignment control ability is coated with reactant solution. (step S22). Prior to describing this step, a step of preparing the substrate whose surface has alignment control ability (step S21) will be described.

(Step S21: Preparation of Substrate Whose Surface has Alignment Control Ability.

It is preferable in this invention to use a substrate which has regularity at an atomic level such as (110) plane of silicon single crystal and cleaved surfaces of mica and graphite. Since such substrates have intrinsic alignment control ability, can be used without further treatment. General substrates such as a glass substrate can be employed in the present invention after a treatment to provide alignment control ability. Although the material of the substrate to which the treatment is applied is not specifically limited, it is preferable that the substrate is stable under reactant solution. For example, silica glass, ceramics, resin and the like can be used.

An example of the treatment to provide alignment control ability to above-mentioned general substrates is a forming of rubbing-treated polymer film (coating).

In this rubbing process, a polymer film on a substrate prepared by spin coating or the like is rubbed with cloth. The rubbing cloth is generally attached around a roller (rubbing roller). The rubbing treatment is made by pressing the rotating rubbing roller on the polymer-coated substrate. In this invention, in place of the rubbing-treated polymer compound film, a Langmuir-Blodgett film (LB film) can be used. As compared to the above-mentioned rubbing-treated polymer compound films, LB films provide more uniform substrate surface although it takes a longer time to prepare LB films. In some cases, the rubbing process is associated with a problem of scratches depending upon the rubbing conditions. By using an LB film, a substrate surface having considerably less defects can be obtained.

Because the coating process with a reactant solution, to be described later, is made for more uniform surfaces, structurally more uniform mesostructured silica and mesoporous silica is obtainable. LB films are prepared by transferring a Langmuir monolayer that is developed on a water surface onto a substrate. By repeating the film deposition process, LB films with desired number of layers can be formed.

The LB film in this invention intends to include a film consists of single-molecule lamination film of an LB film derivative which is formed by making an LB film formed on a substrate be subjected to a process such as a heat treatment to change chemical structure while the layered structure is maintained.

A general method is used for preparing an LB film.

A general LB film preparation system is schematically shown in FIG. 1. Referring to FIG. 1, reference numeral 11 represents a water trough filled with pure water 12. Reference numeral 13 represents a fixed barrier with an unrepresented surface pressure sensor. A monolayer 16 on the water surface is formed by dispensing solution of the target substance or precursor of the target substance onto the water surface between the variable barrier 14 and the fixed barrier 13. By moving the bariable barrier 14, surface pressure is applied. The position of the variable barrier 14 is controlled by the surface pressure sensor so that constant surface pressure is applied while the film is transferred onto a substrate 15.

Pure water is supplied by unrepresented water supply and drain apparatus to keep the solution clean.

A recession is formed in the trough 11 and a substrate 15 is held at this position. The substrate can be moved up and down at a constant speed by an unrepresented translation apparatus. A film on the water surface is transferred onto the substrate when the substrate is dipped into the water and withdrawn from the water.

The LB film of the present invention is formed using such a system in which the substrate 15 is dipped into and withdrawn from the water one after another while a surface pressure is applied to a monolayer developed on the water surface.

The shape and the quality of the film are controlled by surface pressure, speed of the substrate movement for dipping/withdrawing, and the number of layers. The optimum condition of the surface pressure during the LB film deposition is determined from a surface area—surface pressure curve, and generally set to a value of several mN/m to several tens mN/m. The speed of the substrate motion is generally several mm/min to several hundreds mm/min.

The method described above is generally used as an LB film-preparation method. However, the method of preparing an LB film employed in the present invention is not limited to that. For example, a method using a sub-phase water flow can also be used.

As a material for an LB film used in the present invention, a polymer compound such as polyimide is preferably used. However, the material is not specifically limited and any material achieving a satisfactory orientation can be used.

A polyimide LB film can be prepared by a method described in, for example, “Applied Physics Letters” vol. 61, page 3032.

As described above, a substrate whose surface has alignment control ability is prepared by the step S21.

(Step S22: Coating the Substrate Prepared in Step S21 with Reactant Solution)

Next, the substrate prepared in the step S21 is coated with reactant solution.

The coating can be performed in the air or in a nitrogen or argon containing atmosphere. Furthermore, a step S22 can be performed in an oxidation atmosphere or in a reducing atmosphere containing hydrogen.

Preferably, the reactant solution (especially the solvent thereof) on the substrate is dried after the step S22 prior to proceed to a step S3. For example, it is preferable that the step S3 be performed subsequent to a solvent drying step in which the solvent is dried at a temperature in the range of 25° C. to 50° C. and at a humidity of 10% to 30% after the step S22.

Furthermore, it is desirable that the humidity and the temperature be not suddenly but gently varied when proceeding from the solvent drying step to the step S3. The humidity and the temperature are gently varied by a method varying the humidity and the temperature smoothly with humidity gradient or temperature gradient or stepwise.

Any well known coating method can be employed for the method of coating the substrate with reactant solution. For example, cast coating, spin coating, dip coating, spray coating or the like can be used. Other methods can also be used so long as they can coat the substrate with the reactant solution.

Dip coating is convenient because it affords facile coating in a short time. According to this method, a substrate is dipped into a reactant solution and subsequently withdrawn from it, affording the formation of a highly uniform coating. The coating amount, i.e., the thickness of the thin film to be formed, can be controlled, for example, by a substrate withdrawing speed.

The spin coating method is useful for preparing a film having a uniform thickness. The spin coating method includes dropping the reactant solution onto the substrate and spinning the substrate to uniformly coat the substrate with the reactant solution thereon. A coating amount, which corresponds to the thickness of a thin film to be formed, can be controlled by varying the spinning speed of the substrate.

Generally, the film is thin if the spinning speed is fast and the film is thick if the spinning speed is slow.

Furthermore, a mesostructured film in a desired pattern can be prepared on a substrate by selectively coating the substrate with the reactant solution using an inkjet method, a pen lithography method or the like.

For example, the pen lithography method is useful for making a continuous pattern such as a line shape. In this method, the reactant solution is used like ink and a line is drawn by coating with the solution from a penpoint. The width of a line can be freely varied in the order of from μm to mm by varying the shape of the pen, the motion speed of the pen or the substrate, the rate of the reactant solution supply to the pen, or the like.

Any desired pattern such as a straight line or a curved line can be drawn. Furthermore, it is possible to make two-dimensional pattern by overlapping the spread of the reactant solution which the substrate was coated with.

On the other hand, the inkjet method is much useful for drawing an uncontinuous pattern such as a dot pattern. In this method, the reactant solution is used like ink and a constant volume of the solution is ejected as a droplet from an inkjet nozzle.

A line pattern or two-dimensional pattern can be drawn by overlapping the spread of the reactant solution which the substrate was coated with.

Currently, since a amount of a single droplet by the inkjet method is controllable in a several pl (picoliters) scale, the method is advantageous in making an extremely fine dot pattern. Therefore, the inkjet method is advantageous for pattering a fine dot shape.

Furthermore, according to those coating methods such as the pen lithography method and the inkjet method, a desired pattern can be easily determined by using a computer system such as CAD.

Therefore, in the case where various patterns are formed on various substrates, the above-mentioned methods are especially advantageous in view of productivity compared to a conventional photolithographic patterning. This is because the above-mentioned methods are not required to change a photomask depending on a pattern to be formed.

As described above, the substrate is coated with reactant solution by the step S22.

(Step S3: Holding the Substrate which Has Been Coated with Reactant Solution in a Vapor-Containing Atmosphere)

Next, a step of holding a substrate which has been coated with a reactant solution in a vapor-containing atmosphere to form a mesostructured film will be described.

Hydrolysis and condensation rates of a precursor material can be controlled and structured ordering of an assembly of an amphiphilic material is improved, by controlling temperature and humidity.

Therefore, the temperature and humidity can be controlled depending on reactivity of the precursor material to be used, characteristics of the amphiphilic material, or the like. For example, the humidity is preferably controlled so that a relative humidity is in the range of 40% to 100%. If the relative humidity is less than 40%, a highly ordered mesostructured material is hardly obtained or very long holding time is required in the step S3.

Furthermore, even in the case of the 100% relative humidity, it is preferred that the substrate be held in a vapor phase not in water.

Furthermore, excessive temperature rise causes extremely rapid condensation. As a result, a uniform thin film may be hardly formed.

On the other hand, if the temperature is too low, an evaporating rate of a solvent is reduced. As a result, it takes much time for preparing a thin film.

Therefore, the temperature of the atmosphere improving structural ordering of an assembly of an amphiphilic material is preferably room temperature to 100° C.

The temperature and the humidity in the step S3 may be constant or varied. For example, the temperature and the humidity can be controlled so that the above-mentioned temperature and humidity ranges are included in at least a part of the constant or varying temperature and humidity ranges.

Furthermore, it is possible to vary a pore size by varying the above-mentioned temperature. A pore size is large if the temperature is raised and a pore size is small if the temperature is reduced.

Furthermore, the holding time is appropriately determined depending on reactivity of the precursor material to be used, temperature and humidity.

In addition, it is preferred that water contained in the reactant solution on the substrate be dried after the step S3.

The water drying step may be a drying at room temperature or a heat drying. However, the water drying step is not specifically limited so long as water contained the reactant solution on the substrate is reduced. For example, preferably used method is holding a substrate in an atmosphere in which a temperature is controlled in the range of 25° C. to 100° C. and a humidity is controlled in the range of 10% to 30%.

Furthermore, it is desirable that the humidity and the temperature be not suddenly but gently varied when proceeding from the step S3 to the water drying step. The humidity and the temperature are gently varied by a method of varying the humidity and the temperature smoothly with humidity gradient or temperature gradient or stepwise.

A highly ordered mesostructured material is prepared through the step S3. Since the substrate having alignment control abilities used mesostructred film with uniaxially aligned mesopores can be formed.

Furthermore, a mesoporous film having hollow pores uniaxially aligned can be formed by performing a step S4 (described later) to remove the amphiphilic material.

In the present invention, the thickness of the mesostructured film after being subjected to the step S3 is possibly 0.01 μm to several μm or ten and several μm.

For example, in the case of using the dip coating method, a thin film having a thickness of 0.2 μm to 3 μm can be prepared. In the case of using the cast coating method, a thin film having a thickness of 2 μm to 10 μm can be prepared. Needless to say, the thickness is not limited thereto.

Furthermore, in accordance with International Union of Pure and Applied Chemistry (IUPAC), porous materials are classified into microporous materials each having a pore diameter of 2 nm or less, mesoporous materials each having a pore diameter of 2 to 50 nm, and macroporous materials each having a pore diameter of 50 nm or more.

In the present invention, as described above, the pore diameter can be appropriately varied by the surfactant or a treatment temperature. Especially, a large effect is expected for forming a mesostructure and a mesoporous material each having a larger pore diameter than that of a microporous material.

Generally, a mesostructured material means a material which has pores filled with a certain material such as surfactants and a material which has hollow pores. A mesoporous material means a material having hollow pores. In the present specification, the materials are defined similarly.

Furthermore, in the present invention, it is possible to produce a mesostructured material containing a metal oxide crystallites in pore wall.

Next, crystallites in pore wall will be described.

For example, in the case where tin compound which is precursor material for tin oxide is used as precursor material, the tin compound or intermediate derived from the tin compound and surfactant are self-organized with each other, and assemblies of the surfactant form micelles to act as template of pore in the reactant solution on the substrate, thereby preparing a mesostructure.

Then, by performing the step S3 for holding the substrate in an atmosphere under controlled temperature and humidity ordering of the mesostructure is significantly improved.

Furthermore, it is possible to prepare mesostructured tin oxide film having oriented channel structure by an effect of a substrate whose surface has alignement controlability.

In addition, the inventors of the present invention have found that a mesostructured film having crystallites in pore wall could be obtained by performing the above-mentioned step S3.

Hereinafter, description will be made of preferred conditions of an atmosphere to prepare mesostructured tin oxide film containing a microcrystal in a pore wall (in the step S3).

The humidity in the above-mentioned step S3 is in a saturated vapor-containing atmosphere or 40% or more, preferably 60% or more, and still more preferably 70% or more.

The temperature in the above-mentioned step S3 is 15° C. or more and 100° C. or less, and preferably in the range of 25° C. to 60° C.

According to the present invention, mesostructured material containing metal oxide crystallites in pore wall can be obtained by performing the step S3 at a low temperature of 100° C. or less as described above while it is containing surfactant in the pore and maintaining highly ordered structure.

As another method for forming crystal, a method of calcination at a high temperature such as 400° C. is reported in “NATURE” vol. 396, page 152 (1998).

However, such a method is not preferred because there is a high possibility that such high temperature calcination deteriorates structural ordering of the material.

Furthermore, a surfactant is decomposed and removed by such high temperature calcination.

The fact that a surfactant is held in a pore like a mesostructured material of the present invention containing a crystallites in pore wall is preferable in terms of strength of the structure.

It is also possible to provide a function by using a surfactant having such a function or by having a surfactant and a functional material coexist in a reactant solution.

Here, the term “function” means, for example, a function providing conductivity by irradiation with light.

The inside of the pore wall may be entirely or partially crystallized. However, if a desired function appears, the inside may be in a polycrystal or microcrystal state.

The crystallite size in a pore wall of a mesostructured material that contains a metal oxide can be varied by controlling the humidity and temperature in the step S3. It is also possible to promote crystallization by extending the holding time in the step S3.

Needless to say, a surfactant can be removed or the amount thereof can be reduced after a pore wall is crystallized.

For example, a general method such as ultraviolet radiation, oxidative decomposition by ozone, extraction with a supercritical fluid or extraction with a solvent described in a step S4 later is applicable.

A mesostructured film containing a metal oxide and having oriented channel structure can be formed by performing the above-mentioned steps S1 to S3.

Furthermore, in the present invention, a step S4 of removing surfactant micelle as template present in the pore of the mesostructured material may further be included to prepare mesoporous film.

(Step S4: Removal of Surfactant)

As a method for removing a surfactant, a general method such as extraction with a supercritical fluid or a solvent is used.

Removal of a surfactant by calcinations is also a generally used method and the surfactant is almost entirely removed from mesostructured material. However, this method has a possibility that ordering of mesostructure may be lowered or a restriction that a substrate having resistance against calcinations must be used.

A mesoporous film can be prepared on a substrate made from a material having no resistance against calcinations by using extraction with a solvent, although entire (100%) removal of a surfactant is hardly achieved.

In addition to the above-mentioned methods, another method such as removal by UV radiation or removal by O₃ is applicable.

As described above, a main point of the present invention is to prepare mesostructured film having oriented channel structure. Such a film is obtained by coating the substrate whose surface has alignement control ability with reactant solution and holding the substrate in an atmosphere under controlled temperature and humidity to control hydrolysis and condensation rates and to allow the assembly of the amphiphilic material acting as a template to be uniaxially aligned by an effect of the alignement control ability of the substrate.

(Mesostructured Metal Oxide Film)

A mesostructured material according to an embodiment of the present invention is a mesostructured metal oxide (especially, non-silica oxide) film having substantially oriented rod-like pore structure.

A rod-like pore in the present invention includes a cylindrical shape, a polygonal pole similar thereto, and a distorted shape having, for example, an elliptic cross section.

A pore diameter means a size of a pore, that is, a cross-sectional diameter in the case where the pore has a cylindrical shape. In the case where the pore has a polygonal pole shape, a pore diameter means one obtained by multiplying by two the distance between the center of the pore and the vertex thereof. However, in this case, the polygon can be substantially regarded as a circle and the pore diameter can be considered to be the diameter of the circle.

In order to quantitatively evaluate the alignment of the meso-channels in the mesostructured thin film, an in-plane x-ray diffraction analysis was made.

This method measures an in-plane rotation angle dependence of the x-ray diffraction intensity of (110) plane that is perpendicular to the substrate surface, and provide the information about the direction of the channel alignment and its distribution, as described in “chemistry of Materials”, Vol. 11, p. 1609.

If at least 60% of the pores are oriented within the range of −40° to +40° in the distribution of the channel alignment as a result of the above-mentioned evaluation method, the pores are regarded as being substantially uniaxially aligned.

Here, the film includes not only a continuous film but also a patterned film in which a film-shaped structured material is arranged in a fine pattern such as a line pattern, or a dot pattern.

Furthermore, a mesostructured material according to the present invention preferably contains a transition metal (especially, tin).

Especially, a mesostructured material containing tin oxide is capable of providing a mesostructured film containing crystal in pore wall. The crystallized tin oxide is expected to have conductivity.

Furthermore, it is also possible to provide a mesostructured material containing crystallites in pore wall while maintaining surfactant in pore and having highly ordered structure.

Two steps (i.e., removal of a surfactant and incorporating functional material) can be omitted by using a method of holding a functional material in a pore by providing a surfactant held in the pore with functionality or having a surfactant and a functional material coexist at the time of preparing a mesostructured material. As a result, there arises no concern of collapse of the mesostructure due to the removing process or the like.

### Another Embodiment

Application examples of the meso porous film described in the above-mentioned embodiment will be described.

Application examples of the meso porous film include a filter for selecting or adsorbing various materials, or a sensor.

### EXAMPLES

Hereinafter, the present invention will be described in more detail by showing examples. However, the present invention is not limited to those examples, and a material, a reaction condition and the like can be freely modified so long as a mesostructured inorganic oxide film having a similar structure is obtained.

### Example 1

In this example, a mesostructured metal oxide film having uniaxially aligned channel structure was prepared by using stannic chloride as precursor material and silicon monocrystal (110) surface as a substrate whose surface has alignement control ability.

Initially, 1.0 g of polyoxyethylene (10) stearylether <C₁₆H₃₇(CH₂CH₂O)₁₀OH> was dissolved in 10 g of ethanol and the solution was stirred for 30 minutes. Then, 2.9 g of stannic chloride was added thereto and the mixture was stirred for an additional 30 minutes to prepare a reactant solution.

Then, the surface of an n-type silicon (110) substrate having a volume resistivity of 1 to 2 Ω·cm was treated with an HF solution to remove an oxide.

The pre-treated silicon (110) substrate was coated with the reactant solution by the dip coating method.

A withdrawing speed was 2 mm/sec.

The substrate which had been coated with the reactant solution was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result, a thin film was prepared on the substrate. The film was uniform and transparent without any crack.

Next, the thin film prepared on the substrate was subjected to an X-ray diffraction analysis. As a result, a strong diffraction peak assigned to the (100) plane of hexagonal structure was observed at lattice distance of 4.9 nm. Therefore, it was confirmed that rod-like pore structures were formed substantially parallel to the substrate.

The mesostructured film was subjected to an in-plane X-ray diffraction analysis to quantitatively evaluate alignement of the mesochannel in the mesostructured film.

As a result of the in-plane X-ray diffraction analysis, it was found that the mesostructured film prepared in this example had uniaxially aligned channel structure with the alignment distribution of about 68°, estimated from a value of the full-width-at-half-maximum of the diffraction profile.

As described above, it was confirmed that a mesostructured tin oxide film having a uniaxially aligned channel structure can be prepared on a substrate by a method according to the present invention.

### Example 2

In this example, a mesostructured metal oxide film having uniaxially aligned channel structure was prepared by using stannic chloride as a precursor material and a glass plate on which rubbing-treated polymer thin film has been formed as a substrate whose surface alignement control ability.

Initially, the same reactant solution as a reactant solution prepared in Example 1 was prepared.

Next, the glass plate was cleaned by acetone, isopropanol and pure water, and the surface thereof was cleaned in an ozone producing apparatus. Then, an NMP solution of polyamic acid A was applied onto the glass plate by a spin coating method and was baked at 200° C. for 1 hour to convert into the polyimide A having the following structure:

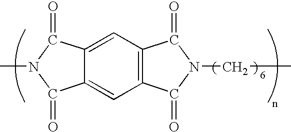

The entire film on the glass plate was subjected to a rubbing treatment along one direction in accordance with conditions as shown in Table 1 below.

TABLE 1
Rubbing conditions for polyimide A

| Cloth material | Nylon |
|---|---|
| Roller diameter (mm) | 24 |
| Depression (mm) | 0.4 |
| Rotation Speed (rpm) | 1000 |
| Stage speed (mm/mm) | 600 |
| Repetition | 2 |

Then, the substrate was coated with the reactant solution by a dip coating method.

A withdrawing speed in the dip coating was 2 mm/sec.

The substrate which had been coated with the reactant solution was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result, a thin film was prepared on the substrate. The thin film was uniform and transparent without any crack.

Next, the thin film prepared on the substrate was subjected to an X-ray diffraction analysis. As a result, almost the same results as in Example 1 were obtained, and it was confirmed that the method of the present invention provided the mesostructured tin oxide thin film was having rod-like pore structure.

Furthermore, the thin film prepared on the substrate was subjected to an in-plane X-ray diffraction analysis. As a result of the in-plane X-ray diffraction analysis, it was found that the mesostructured film prepared in this example had uniaxially aligned channel structure with the alignment distribution of about 50°, estimated from a value of the full-width-at-half-maximum of the diffraction profile.

Therefore, those results confirmed that mesostructured tin oxide film having a uniaxially aligned channel structure could be prepared on a substrate by the method according to the present invention.

### Example 3

In this example, mesostructured metal oxide thin film having a uniaxially aligned channel structure was prepared by using stannic chloride as precursor material and substrate on which an LB film of polyimide A was formed as a substrate whose surface has alignment control ability.

Initially, a reactant solution similar to that prepared in Example 1 was prepared.

The glass substrate was cleaned by acetone, isopropanol and pure water, and the surface thereof was cleaned in an ozone producing apparatus.

Next, polyamic acid A and N,N-dimethylhexadecylamine were mixed in a molar ratio of 1:2 to produce N,N-dimethylhexadecylamine salt of polyamic acid A.

The salt was dissolved in N,N-dimethylacetamide to prepare a 0.5 mM solution and the solution was dropped onto a water surface in an LB film producing apparatus kept at 20° C.

A mono layer formed on the water surface was transferred to the substrate at a dipping speed of 5.4 mm/min while being applied with a constant surface pressure of 30 mN/m.

After an LB film consists of 30 layers of polyamic acid alkylamine salt was formed on the substrate, the substrate was baked at 300° C. for 30 minutes under a flow of nitrogen gas, thereby forming an LB-film of polyimide A.

Transformation of polyamic acid to polyimide through dehydration ring closure and desorption of alkylamine were confirmed by infrared spectroscopy.

Next, the substrate was coated with the reactant solution by a dip coating method in the same manner as in Example 1.

A withdrawing direction of the substrate in the dip coating was set perpendicular to the movement direction of the substrate in forming an LB film.

The substrate which had been coated with the reactant solution was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result, a thin film was prepared on the substrate. The film was uniform and transparent without any crack.

Next, the thin film prepared on the substrate was subjected to an X-ray diffraction analysis. As a result, almost the same results as in Example 1 were obtained, and it was confirmed that the method of the present invention provided the mesostructured tin oxide thin film was having rod-like pore structure.

Furthermore, the thin film prepared on the substrate was subjected to an in-plane X-ray diffraction analysis. As a result of the in-plane X-ray diffraction analysis, it was found that the mesostructured film prepared in this example had uniaxially aligned channel structure with the alignment distribution of about 52°, estimated: from a value of the full-width-at-half-maximum of the diffraction profile.

As described above, it was confirmed that mesostructured tin oxide film having uniaxially aligned channel structure could be prepared on a substrate by the method according to the present invention.

### Example 4

In this example, mesostructured tin oxide-film having a uniaxially aligned channel structure was produced by using stannic chloride as precursor material, substrate on which rubbing-treated polymer thin film has been formed as substrate whose surface has alignement control ability and spin coating method as a coating method with reactant solution.

Initially, a reactant solution the same as a reactant solution prepared in Example 1 was prepared.

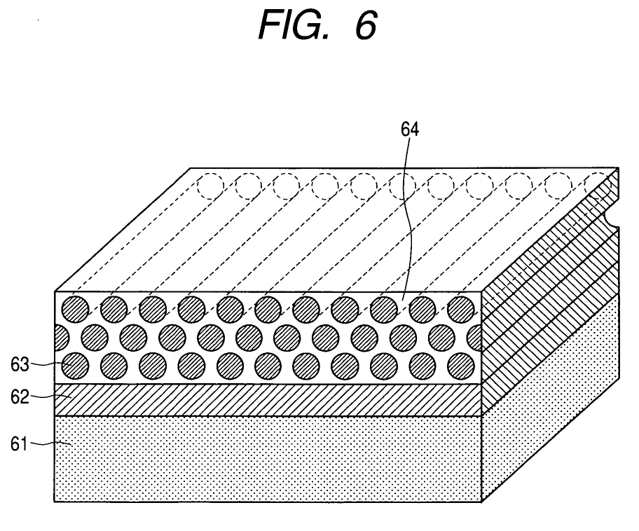

Then, as shown in FIG. 6, rubbing-treated polymer thin film 62 was prepared on the surface of the substrate 61 in the same manner as in Example 2.

Then, the substrate was coated with the reactant solution by a spin coating method.

The spin coating was carried out at a spinning speed of 2,000 rpm for 20 seconds.

The substrate which had been coated with the reactant solution was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result, a thin film was prepared on the substrate. The thin film was uniform and transparent without any crack or the like being recognized.

Next, the thin film prepared on the substrate was subjected to an X-ray diffraction analysis. As a result, almost the same results as in Example 1 were obtained, and it was confirmed that the method of the present invention provided the mesostructured tin oxide thin film having a rod-like pore structure 63 oriented substantially parallel to the substrate 61 as shown in FIG. 6.

Furthermore, the thin film prepared on the substrate was subjected to an in-plane X-ray diffraction analysis. As a result of the in-plane X-ray diffraction analysis, it was found that the mesostructured film prepared in this example had uniaxially aligned channel structure with the alignment distribution of about 50°, estimated from a value of the full-width-at-half-maximum of the diffraction profile.

Therefore, those results confirmed that mesostructured tin oxide film having uniaxially aligned channel structure could be prepared on substrate by the method according to the present invention.

### Example 5

In this example, a pattern of a mesostructured tin oxide-film having a uniaxially aligned channel structure was prepared by using stannic chloride as precursor material, substrate on which a rubbing-treated polymer thin film has been formed as substrate whose surface has alignement control ability, and pen lithography method as coating method with reactant solution.

Initially, reactatn solution similar to that prepared in Example 1 was prepared.

Then, rubbing-treated polymer thin film was formed on the surface of the substrate in the same manner as in Example 2.

Then, as shown in FIG. 3, the substrate 21 was coated with the reactatn solution by pen lithography method to form pattern 22 of the reactant solution.

Conditions of the pen lithography were as follows: a pen orifice of 50.0 μm, a substrate motion speed of 2.5 cm/sec, and the reactant solution supply rate of 4.0 cm/sec.

The substrate which had been coated with the reactant solution was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result of observation of the treated substrate, it was confirmed that a transparent, continuous, and uniform thin film was formed only at areas which was coated with the reactant solution by a pen lithography method, as shown in FIG. 3.

The substrate on which the patterned transparent thin film was prepared was subjected to an X-ray diffraction analysis in the same manner as in Example 1. As a result, almost the same results as in Example 2 were obtained, and it was confirmed that the method of the present invention provided the mesostructured tin oxide thin film having a rod-like pore structure.

Furthermore, as for the in-plane X-ray diffraction analysis, almost the same results as in Example 2 were obtained. As a result, it was confirmed that the method according to the present invention-provide mesostructured tin oxide film having uniaxially aligned channel structure which could be formed on any desired area of a substrate in any desired pattern.

### Example 6

In this example, a pattern of mesostructured tin oxide film having a uniaxially aligned channel structure was prepared by using stannic chloride as precursor material, substrate on which rubbing-treated polymer thin film had been formed as substrate whose surface has alignment control ability and an ink-jet method as an coating method with reactant solution.

Initially, a reactant solution similar to that prepared in Example 1 was prepared.

Then, rubbing-treated polymer thin film was formed on the surface of the substrate in the same manner as in Example 2.

Then, as shown in FIG. 3, the substrate was coated with the reactant solution by the inkjet method in the same manner as in Example 5.

The substrate on which the reactant solution had been coated with was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 5 hours, lowering humidity at 1%/hour, and then holding the substrate at 40° C./20% RH.

As a result of observation of the treated substrate, it was confirmed that a transparent, continuous, and uniform thin film was formed only at areas which was coated with the reactant solution by the ink jet method, as shown in FIG. 4.

The substrate on which the patterned transparent thin film was prepared was subjected to an X-ray diffraction analysis in the same manner as in Example 1. As a result, almost the same results as in Example 2 were obtained. Therefore, it was confirmed that the method of the present invention provided the mesostructured tin oxide thin film having a rod-like pore structure.

Furthermore, as for the in-plane X-ray diffraction analysis, almost the same results as in Example 2 were obtained. As a result, it was confirmed that the method according to the present invention provide mesostructured tin oxide film having uniaxially aligned channel structure which could be formed on any desired area of a substrate in any desired pattern.

### Example 7

In this example, mesostructured tin oxide film having uniaxially aligned channel structure and having pore wall containing microcrystal was prepared by using stannic chloride as a precursor material, substrate on which rubbing-treated polymer thin film has been formed as substrate whose surface has alignment control ability, and dip coating method as an coating method with reactant solution.

Initially, a reactant solution similar to that prepared in Example 1 was prepared.

Then, rubbing-treated polymer thin film was formed on the surface of the substrate in the same manner as in Example 2.

Next, the substrate was coated with the reactant solution by a dip coating method.

A withdrawing speed in the dip coating was 2 mm/sec.

The substrate on which the reactant solution had been applied was held in an environmental test apparatus capable of controlling humidity and temperature in the air.

In the environmental test apparatus, conditions varied as follows: holding the substrate at 40° C./20% RH for 10 hours, raising humidity at 1%/minute, holding the substrate at 40° C./80% RH for 150 hours, lowering humidity at 1%/hour, and holding the substrate at 40° C./20% RH.

As a result, a thin film was formed on the substrate. The thin film was uniform and transparent without any crack.

Next, the thin film prepared on the substrate was subjected to an X-ray diffraction analysis. As a result, a strong diffraction peak assigned to the (100) plane of hexagonal structure was observed at lattice distance of 4.6 nm. Therefore, it was confirmed that rod-like pore structures were formed substantially parallel to the substrate.

Furthermore, the thin film formed on the substrate was subjected to an in-plane X-ray diffraction analysis. As a result of the in-plane X-ray diffraction analysis, it was found that the mesostructured film prepared in this example had uniaxially aligned channel structure with the alignment distribution of about 50°, estimated from a value of the full-width-at-half-maximum of the diffraction profile.

Furthermore, the thin film formed on the substrate was subjected to X-ray diffraction analysis for thin film measurement. As a result, clear peaks were observed at 2θ=26.6°, 33.9°, 51.7°, which are assigned to SnO₂ Cassiterite. This means that there exists microcrystal in pore wall while the mesostructure is maintained.

Also, the full-width-at-half-maximum of the diffraction profile in the range of 2θ=21° to 31° were estimated. Then, the average crystallite size L was calculated by a Scherrer method to be 2 nm. The Scherrer equation is as follows:
L=0.9λ/B cos θ

As a result of the above-mentioned evaluation, it was confirmed that the method according to the present invention provided mesostructured tin oxide film having uniaxially aligned channel structure and pore wall containing microcrystals.

### Example 8

In this example, mesostructured metal oxide film having uniaxially aligned channel structure was prepared by using stannic chloride as precursor material, substrate on which rubbing-treated polymer thin film has been formed as substrate whose surface has aligned control ability and dip coating method as coating method with reactant solution. Furthermore, mesoporous tin oxide thin film having uniaxially oriented pore structure was prepared by removing surfactant.

Initially, 1.0 g of triblock copolymer HO(CH₂CH₂O)₂₀(CH₂CH(CH₃)O)₇₀(CH₂CH₂O)₂₀H was dissolved in 10 g of ethanol and the solution was stirred for 30 minutes. Then, 2.9 g of stannic chloride was added thereto and the mixture was stirred for an additional 30 minutes to prepare reactant solution.

Then, rubbing-treated polymer thin film was formed on the surface of the substrate in the same manner as in Example 2.

Next, the substrate was coated with the reactant solution by a dip coating method. A withdrawing speed in the dip coating was 1 mm/sec.

The substrate on which the reactant solution had been coated with was held in an environmental test apparatus capable of controlling humidity and temperature in air.

In the environmental test apparatus, conditions varied as follows: holding the substrate at 40° C./20% RH for 10 hours, raising temperature and humidity to 50° C./90% RH gradually for 1 hour, holding the substrate at 50° C./90% RH for 5 hours, lowering temperature and humidity to 40° C./20% RH for 1 hour again, and holding the substrate at 40° C./20% RH.

As a result, a thin film was formed on the substrate. The thin film was uniform and transparent without any crack.

Next, the thin film prepared on the substrate was subjected to an X-ray diffraction analysis. As a result, a strong diffraction peak assigned to the (100) plane of hexagonal structure was observed at lattice distance of 7.8 nm. Therefore, it was confirmed that rod-like pore structures were formed substantially parallel to the substrate.

Furthermore, the substrate on which the tin oxide mesostructure thin film was formed was put in a muffle furnace and heated to 300° C. to be calcined in air.

Significant difference was not observed between the property such as uniformity or transparency of the thin film after calcination and that before calcination.

It was confirmed by infrared spectroscopy that organic substance derived from the surfactant did not remain in the sample after the calcination.

Next, the thin film after the calcination was also subjected to an X-ray diffraction analysis. As a result, a strong diffraction peak was observed at a lattice distance of 5.0 nm, and it was confirmed that a channel structure was maintained after the calcination though vertical shrinkage of the periodic structure were observed, and that mesoporous tin oxide thin film was formed.

Furthermore, the thin film after the calcination was subjected to an in-plane X-ray diffraction analysis. As a result, it was found that the mesoporous thin film prepared in this example had uniaxially aligned pore and the alignmend distribution of about 70°, estimated from a value of the full-width-at-half-maximum of the diffraction profile.

As a result of the above-mentioned result, it was confirmed that the method according to the present invention provided uniform and continuous mesoporous tin oxide thin film having uniaxially aligned pore structure on substrate.

As described above, according to the preparing method of the present invention, mesostructured film containing metal oxide and having oriented channel structure can be prepared.

Furthermore, according to the present invention mesostuructured film containing tin oxide has uniaxially aligned rod-like pores and is expected to be applied to electronic device, optical device and various other uses.

1. A method for producing a mesostructred film film comprising the steps of:
preparing a reaction solution containing a precursor material for mesostructred film which contains a metal oxide, and an amphiphilic material;
applying the reaction solution onto a substrate having a capability of orienting an aggregate of the amphiphilic material in a predetermined direction; and
forming the mesostructred film having a plurality of the aggregates of the amphiphilic material oriented in the predetermined direction while holding the substrate onto which the reaction solution has been applied in a vapor-containing atmosphere.

2. A method for producing a mesostructred film according to claim 1, wherein the precursor material contains tin.

3. A method for producing a mesostructred film according to claim 1, wherein the precursor material is a metal chloride.

4. A method for producing a mesostructred film according to claim 1, wherein the amphiphilic material is a surfactant.

5. A method for producing a mesostructred film according to claim 1, wherein the step of forming the mesostructred film having a plurality of aggregates of the amphiphilic material oriented in the predetermined direction is performed at a temperature of 100° C. or less.

6. A method for producing a mesostructred film according to claim 1, wherein the step of forming the mesostructred film having a plurality of aggregates of the amphiphilic material oriented in the predetermined direction is performed at a relative humidity in a range of from 40% to 100%.

7. A porous film on a substrate, comprising a plurality of tube-shaped pores oriented in a predetermined direction and containing a metal oxide in a pore wall of the porous film.

8. A porous film according to claim 7, the porous film comprising tin oxide in the pore wall.

9. A porous film according to claim 7, wherein the tube-shaped pores are mesopores each having a pore diameter of from 2 nm to 50 nm.

10. A porous film according to claim 7, wherein the pores hold an aggregate of an amphiphilic material.

11. A porous film according to claim 7, wherein at least 60% of the tube-shaped pores are oriented within a range of −40° to +40° in an orientation direction distribution as measured by an in-plane X-ray diffraction analysis.

12. A porous film according to claim 7, wherein the substrate has a capability of orienting the aggregate of the amphiphilic material in the predetermined direction.

13. A porous film according to claim 12, wherein the substrate having the capability of orienting the aggregate of the amphiphilic material in the predetermined direction is a substrate on the surface of which a polymer compound film provided with anisotropy has been formed.

14. A porous film according to claim 12, wherein the substrate having the capability of orienting the aggregate of the amphiphilic material in the predetermined direction is a monocrystal substrate having such an orientation that an atomic arrangement at a surface of the substrate has two-fold symmetry.

15. A porous film according to claim 14, wherein the monocrystal substrate is of the (110) surface of silicon monocrystal.

16. A porous film according to claim 12, wherein the substrate having the capability of orienting the aggregate of the amphiphilic material in the predetermined direction is a substrate on the surface of which a polymer compound film provided with anisotropy or a Langmuir-Blodgett film of a polymer compound has been formed.

17. A method for producing a porous film comprising the steps of:
preparing a reaction solution containing a precursor material for a porous material which contains a metal oxide, and an amphiphilic material;
applying the reaction solution onto a substrate having a capability of orienting an aggregate of the amphiphilic material in a predetermined direction;
forming the porous material having a plurality of the aggregates of the amphiphilic material oriented in the predetermined direction while holding the substrate onto which the reaction solution has been applied in a vapor-containing atmosphere; and
removing the amphiphilic material to form a pore.
